(19) United States
(12) Patent Application Publication
(10) Pub. No.: US 2003/0002576 A1
(43) Pub. Date: Jan. 2, 2003

(54) Apparatus and method for compression of data in protection and control communications between protective relays in a power system

(76) Inventors: David E. Whitehead, Pullman, WA (US); Edmund O. Schweitzer III, Pullman, WA (US)

Correspondence Address: JENSEN + PUNTIGAM, P.S., SUITE 1020, 2033 6TH AVE, SEATTLE, WA, 98121, US

(21) Appl. No.: 09/895,479

(22) Filed: Jun. 29, 2001

(51) Int. Cl. H04B 1/66

(52) U.S. Cl. 375/240

(57) ABSTRACT

The data compression system is used for communication between at least two protective relays on a power transmission line. The system is responsive to a linear digital output from an analog to digital converter to which is applied successive analog quantities. At the transmitting protective relay, a logarithmic compression element reduces the number of digital bits to be transmitted while maintaining any errors in the encoding/decoding process to a level acceptable for the existing protection scheme for the power system. The compressed data is transmitted over a communication line to the receiving relay, where it is decoded (expanded) and then used in the relay's protection algorithm.

### TECHNICAL FIELD

This invention relates generally to communication of protection and control information between protective relays for an electric power system and more specifically concerns the transmission of data quantities between the protective relays over a limited bandwidth communication channel.

### BACKGROUND OF THE INVENTION

Protection and control schemes for electric power systems require communication channels for transmission of information concerning status and/or operation of the system between the protective relays for the power system. Referring to FIG. 1, in a typical differential protection arrangement, there is an information exchange between the protective relays 12, 14 associated with a given power line portion 15 of the power system followed by processing of the exchanged information. Fault determinations are made, including distinguishing external faults from internal faults relative to the power line portion associated with the two protective relays.

The exchanged information includes analog and digital quantities. Analog to digital converters (ADCs) operate to convert selected analog quantities, i.e. those quantities obtained from the power line 15, to a digital format for data transmission from one relay to another over a selected communication line 16. The conversion from analog to digital format is linear in that the digital output follows, in a linear fashion, the change in the analog quantity. Both resolution and dynamic range are important issues with respect to the conversion to a digital format. Most protective relays and the processing algorithms which they perform, such as for line current differential protection, require for proper operation high resolution over a relatively large analog range.

A typical analog to digital converter used in protective relay arrangements has a 16-bit output. Typical commercially available communication channels have limited capacity, either 56 or 64 kilobits/second. Further, the protection algorithms are often run every 1/16^{th} of a power system cycle for adequate power system protection and the entire protection information, in message format, is transmitted over the communication channel in real time, i.e. within 1/16th of a power system cycle. With a 56 k bps (bits per second) channel, and a power system frequency of 65 Hertz, 53 bits are available for the transmission of data every 1/16th power system cycle. The transmission bits needed include analog and digital data and security bits. The analog information to be transmitted requires 48 bits (16 bits×3 phases) out of the 53 bits available, leaving little room for status information, error detection, and correction bits, etc.

A 12 bit output ADC could be used to provide additional channel space. However, this would degrade either the dynamic range or the resolution characteristic. Improvement in either the dynamic range or resolution to approximately that of the 16 bit ADC will cause a significant degradation in the other characteristic.

Attempts have been made to resolve the desirability of transmitting additional information relative to the very real limitations on channel space. These solutions include the use of specialized communication lines, as opposed to commercially available lines, and/or transmitting individual analog channel information as a single analog quantity representing all three analog channels. These solutions, however, either add significantly to the expense of the overall system, or affect the quality of the protection for the power line. Sacrificing either resolution or dynamic range typically decreases the protection available to the power system to an unacceptable level. Heretofore, in the context of power line protection, data has been transmitted in a linear, uncompressed state, due to the understanding that compression of the data would have undesirable effects on the overall quality of power system protection.

In applicant's disclosed system set out below, data compression is used to reduce the number of data bits to be transmitted, thereby providing additional bit capacity for other information to be transmitted by the transmitting relay. The present invention does not significantly affect either the dynamic range or the resolution of the transmitted data. The error rate, by careful selection of the data compression parameters, remains at an acceptably low level.

### DISCLOSURE OF THE INVENTION

Accordingly, the present invention is a system for transmitting data between at least two protective relays used for protection and control of an electric power system, wherein the system includes an analog-to-digital converter (ADC) for converting selected analog values useful in said protection and control determined by a first protective relay to linear groups of digital bits representative of the selected analog values, the system comprising: A data compression element for reducing the number of digital bits in the linear digital bit groups in accordance with a selected compression characteristic, such as a logarithmic compression, at a transmitting protective relay; a communication line for transmitting compressed data to a receiving protective relay; and a data expanding element at the receiving relay for converting received compressed data to the original linear group of digital bits, suitable for use in protection algorithms used in the receiving relay, wherein compression/decompression of data at the transmitting and receiving relays is accomplished in such a manner that the error introduced by the compression/decompression of the data will not harm the protection and control of the power system.

### BRIEF DESCRIPTION OF THE DRAWINGS

FIG. 1 shows a simplified diagram of a portion of a power line with two protective relays thereon communicating with each other.

FIG. 2 is a block diagram showing the sequence of the operation of the present invention and the sequence of information transmitted.

### BEST MODE FOR CARRYING OUT THE INVENTION

The present invention is a system for reducing the number of digital bits, representative of initial analog values, to be transmitted between protective relays in a power system, without significant loss of resolution or dynamic range. The system uses data compression, in accordance with a selected compression characteristic. The error produced as a result of the encoding/decoding is relatively small, and is maintained below the specified tolerance level for the selected power system protection scheme. The number of digital bits required to communicate the analog quantities over the communication channel is significantly reduced. In the embodiment described herein, logarithmic encoding is used to compress the linear digital data produced by the ADC (analog-to-digital converter). Other compression encoding methods could be used.

In the present invention, the particular format of the digital data from the ADC will determine whether or not a sign bit is necessary for the compressed (encoded) data. If the data is unipolar (either all positive or all negative), no sign bit is necessary, but if it is bipolar, in which the digital data from the ADC has both positive and negative portions, a sign bit is used to distinguish positive values from negative values.

Typically, the output of an ADC in bipolar format will be in the form of a two's complement arrangement. Other formats, however, can be used. In two's complement format, a negative value is represented by only the most significant bit of the bit string being set to one, while the positive values are represented by ones, with the most significant bit being set to zero. Each analog value to be transmitted is represented first by a 16 bit output from the ADC (for a 16 bit ADC) and then by the number of bits produced by the compression algorithm.

An acceptable error level in the transmission of the data is initially determined. The amount of error is determined by the operating characteristics of the particular protection scheme. It is quite important that the data compression system operate within acceptable error limits of the protection and control scheme. In the present invention, the data compression algorithm is established such that errors are maintained within acceptable limits for the particular protection system.

In the present data compression system, assuming a 16-bit ADC output with a bipolar two's complement format, one sign bit is required; this leaves 2¹⁵ or 32,768 different values possible to cover the magnitude of each analog value to be converted and transmitted.

In the following analysis, this total bit number (32,768 bits) which is the number of bits from a 16 bit ADC (minus the one sign bit), representing the analog quantity obtained by the protection system, is referred to as the max (maximum) linear value. The maximum error tolerable by the system is referred to as max error. The standard logarithmic compression equation for the maximum number of bits following compression is:

max linear value=max error^{maxlog} (equation no. 1).

Using a base 10 log (log 10) and solving for max log, which is the number of digital data bits following compression used to represent the max linear value:

max log=log 10 (max linear value) /log 10 (max error)

max log=log 10 (32,768)/log 10 (1+max error)

max log=log 10 (32,768)/log 10 (1.02), where 32,768 is the maximum linear value, i.e. the maximum number of linear data bits from the uncompressed output of the ADC and 0.02 (2%) is the maximum error tolerable by the particular protective system. Accordingly, max log=4.154/0.0086 or max log=525. Hence, the maximum compressed value (number of bits) required to represent the maximum linear value (32,768 bits) is 525. This value, 525, requires a total of 10 bits (2¹⁰=1024) for full coverage. However, nine bits (2⁹)=512 different values, which is quite close to 525, but still less than needed to fully represent the maximum linear value output of the ADC. Recalculating equation No. 1 using a max log of 512, and solving for maximum error, the maximum error increases only to 2.05%. Typically, such a slight increase in error would be acceptable to gain another bit space for other uses in the communication channel.

Once the max log number has been obtained, the linear data from the ADC is encoded using conventional logarithmic compression. Each string of linear data (16 bits) from the ADC represents one analog value. The encoding is done in accordance with the following equation:

Encoded data=log 10(linear data)/log 10 (1.0205) (equation no. 2)

Encoded data=log 10 (linear data)/8.813×10⁻³

Each encoded data string, representing one output string from the ADC and hence one analog value input to the ADC, is transmitted over the connecting communication line to the receiving protective relay. At the receiving protective relay the data is decoded in reverse fashion, using equation no. 2, solving instead for the linear data equivalent of each compressed data string. The original analog value may thereafter be obtained from the linear data string.

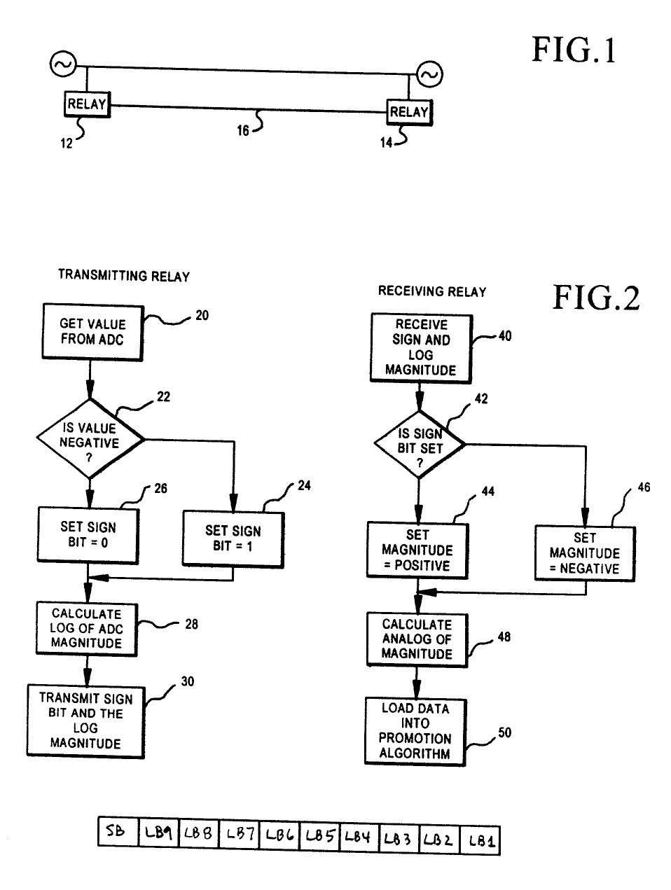

FIG. 2 shows a flow chart for the system of the present invention. Referring to FIGS. 1 and 2, at the transmitting relay 12, the 16 bit digital value equivalent of a particular analog value input from the power line 15 will first be obtained from the transmitting relay's ADC. This is shown at step 20. A determination is then made as to whether the value from the ADC is negative, as shown at step 22. If the answer is yes, i.e. the digital value is negative, then a sign bit portion of the encoded data is set to 1 (step 24), while if the value is not negative, the sign bit is set to 0 (step 26). The log value (encoded value) of the magnitude of the ADC value is obtained, as explained in detail above and shown at step 28, and the encoded (compressed) digital value is transmitted to the receiving relay 14, along with the sign bit (step 30) over communication line 16. The sign bit is transmitted first, followed by a succession of log bits. In the embodiment shown, the data (log bits) is transmitted from most significant bit to least significant bit with a total of 9 bits. This is also shown in FIG. 2, with the bit stream including sign bit (SB) and log bits (LB) 1-9.

With the present invention the communication channel can be a commercially available line, thus saving expense relative to a special line.

At the receiving end of communication line 16, the receiving relay 14 will receive the transmitted sign bit, and the log (encoded) bits (step 40). At step 42, it will first be determined whether the sign bit has been set (to one) or not, indicating a positive (step 44) or negative (step 46) polarity. The anti-log of the transmitted compressed data is then determined, providing the original linear data (step 48), which is then used by the protection algorithm in the receiving protective relay 14 to accomplish its protective functions (step 50).

Communication between the two relays 12, 14 is bi-directional over line 16, so that the original receiving relay can transmit data back to the original transmitting relay.

Accordingly, a system and method has been disclosed for compressing and transmitting digital data between two associated protective relays for a power line portion of a power system. Control over the amount of the error caused by the encoding/decoding compression/decompression system is maintained. The data compression/decompression is an integral part of the protection and control system. In the one example of compression described herein, the encoding reduced the analog representation from 16 to 10 bits, a 37.5% reduction in required bandwidth. The invention thus enables sufficient data to be transmitted to provide a high level of protection for the power system while permitting a substantial amount of additional data to be transmitted, over a conventional communication line, while maintaining strict control over the error created by the encoding/decoding process.

Although a preferred embodiment of the invention has been disclosed for illustration, it should be understood that various changes, modifications, and substitutions may be made in the preferred embodiment without departing from the spirit of the invention which is defined by the claims which follow;

What is claimed is:

1. A system for transmitting data between at least two protective relays used for protection and control of an electric power system, wherein the system includes an analog-to-digital converter (ADC) for converting selected analog values useful in said protection and control determined by a first protective relay to linear groups of digital bits representative of the selected analog values, the system comprising:
a data compression system for reducing the number of digital bits in the linear digital bit groups in accordance with a selected compression characteristic at a transmitting protective relay;
a communication line for transmitting compressed data to a receiving protective relay; and
a data expanding system at the receiving relay for converting received compressed data to the original linear group of digital bits, suitable for use in protection algorithms used in the receiving relay, wherein compression/decompression of data at the transmitting and receiving relays is accomplished such that the error introduced by the compression/decompression of the data will not harm the protection and control of the power system.

2. A system of claim 1, wherein the compressed data includes a sign bit indicating polarity of data to be compressed.

3. A system of claim 1, wherein the compression characteristic is a logarithmic compression.

4. A system of claim 1, wherein the compressed data transmitted to the receiving relay includes a sign bit, followed by a series of encoded bits, arranged from most significant bit to least significant bit.

5. A system of claim 4, wherein the number of bits used to encode linear digital data from the ADC is sufficient to encode the full group of digital bits from the ADC.

6. A system of claim 1, wherein said error introduced is not significantly greater than 2%.

7. A system of claim 5, wherein the compressed data includes 9 bits to cover 16 bits of data from the ADC, leaving a substantial amount of channel space for additional bits to be transmitted along with the compressed data.

8. A method for transmitting data between at least two protective relays used for protection and control of an electric power system, wherein the system includes an analog-to-digital converter (ADC) for converting selected analog values useful in said protection and control determined by a first protective relay to linear groups of digital bits representative of the selected analog values, the method comprising the steps of:
reducing the number of digital bits in the linear digital bit groups in accordance with a selected compression characteristic at a transmitting protective relay;
transmitting the compressed data to a receiving protective relay; and
converting received compressed data at the receiving relay to the original linear group of digital bits, suitable for use in protection algorithms used in the receiving relay, wherein compression/decompression of data at the transmitting and receiving relays is accomplished such that the error introduced by the compression/decompression of the data will not harm the protection and control of the power system.

9. A method of claim 8, wherein the compressed data includes a sign bit indicating polarity of data to be compressed.

10. A method of claim 8, wherein the compression characteristic is a logarithmic compression.

11. A method of claim 8, wherein the compressed data transmitted to the receiving relay includes a sign bit, followed by a series of encoded bits, arranged from most significant bit to least significant bit.

12. A method of claim 11, wherein the number of bits used to encode linear digital data from the ADC is sufficient to encode the full group of digital bits from the ADC.

13. A method of claim 8, wherein said error introduced is not significantly greater than 2%.

14. A method of claim 12, wherein the compressed data includes 9 bits to cover 16 bits of data from the ADC, leaving a substantial amount of channel space for additional bits to be transmitted along with the compressed data.
